(19) United States
(12) Patent Application Publication
(10) Pub. No.: US 2005/0274257 A1
(43) Pub. Date: Dec. 15, 2005

(54) Air purification

(76) Inventor: David Reznik, Los Altos Hills, CA (US)

Correspondence Address: Dekel Patent Ltd.;Beit HaRof'im, Room 27, 18 Menuha VeNahala Street, Rehovot, 76209, IL

(21) Appl. No.: 10/864,407

(22) Filed: Jun. 10, 2004

(51) Int. Cl. B01D 47/02

(52) U.S. Cl. 95/226; 96/329

(57) ABSTRACT

An air purification system including a series of tanks fluidly connected to one another, one tank being fluidly connected to a successive tank, starting from a first tank to a last tank, each tank receiving therein air to be treated, wherein each tank includes a different chemical agent toxic to a different contaminant in the air and wherein air treated by the chemical agent in one tank flows to a successive tank for treatment by the chemical agent in that successive tank.

### FIELD OF THE INVENTION

This invention relates to apparatus and method for treatment of contaminated atmospheres for the purposes of air purification, particularly by chemical treatment to kill microorganisms and the like.

### BACKGROUND OF THE INVENTION

Many systems exist for removing contaminants from gases such as air. For example, the food and electronics industries require clean air for manufacturing processes. Pasteurized or sterilized food should be packaged in enclosures free of microorganisms to prevent contamination of the food product.

Many systems use filtration means to remove microorganisms, such as with the use of biofilters. However, there are several disadvantages with filtration systems. Certain contaminants, such as viruses, may pass through some filters. The filter may become damaged with the result that openings are formed in the filter through which bacteria and other contaminants may pass. The result is that some biofilters may suffer from a lack of reliability and safety.

### SUMMARY OF THE INVENTION

The present invention seeks to provide improved apparatus and methods for treatment of contaminated atmospheres for the purposes of air purification, as is described in detail further hereinbelow.

In accordance with an embodiment of the present invention, air is passed through solutions that are toxic to a variety of microorganisms. For example, chlorine kills bacteria but is not so effective against yeast and mold, whereas sulfur dioxide kills yeast and mold but is not so effective against bacteria. The air may be bubbled through multiple tanks containing solutions toxic to various microorganisms, and may pass through a solution that neutralizes the toxic solutions.

One of the many applications of the present invention is in the packaging industry. In the case of packaging in an enclosure, in addition to the air circulating through the enclosure, air that has been sterilized may be pumped under positive pressure out of the enclosure at points of ingress and egress of packaging materials and food products, for example.

There is thus provided in accordance with an embodiment of the present invention an air purification system including a series of tanks fluidly connected to one another, one tank being fluidly connected to a successive tank, starting from a first tank to a last tank, each tank receiving therein air to be treated, wherein each tank includes a different chemical agent toxic to a different contaminant in the air and wherein air treated by the chemical agent in one tank flows to a successive tank for treatment by the chemical agent in that successive tank.

In accordance with an embodiment of the present invention one or more blowers may force air to flow into at least one of the tanks.

Further in accordance with an embodiment of the present invention, for each tank, the chemical agents may be in a solution, and air may bubble through the solution and exit at the top of the tank.

Still further in accordance with an embodiment of the present invention a droplet separation device may be used to separate droplets of solution from the air stream exiting the tank.

In accordance with an embodiment of the present invention air exiting the last tank may be re-introduced into the first tank. Air that has been treated in the tanks may be pumped out of the enclosure through points of ingress and egress of the enclosure.

There is also provided in accordance with an embodiment of the present invention a method for air purification including introducing air into at least one tank, killing a microorganism in the air with a chemical agent in the at least one tank, extracting purified air from at least one tank that contains no microorganism or chemical, and introducing the purified air into an enclosure.

### BRIEF DESCRIPTION OF THE DRAWINGS

The present invention will be understood and appreciated more fully from the following detailed description taken in conjunction with the drawing in which:

FIG. 1 is a simplified pictorial illustration of an air purification system, constructed and operative in accordance with an embodiment of the present invention.

### DETAILED DESCRIPTION OF EMBODIMENTS

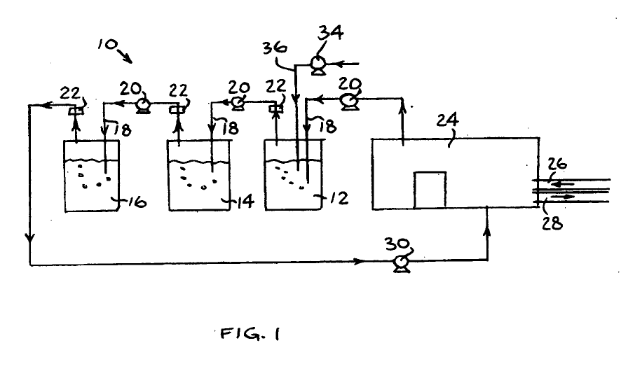

Reference is now made to FIG. 1, which illustrates an air purification system 10, constructed and operative in accordance with an embodiment of the present invention.

The air purification system 10 may include a series of tanks, such as tanks 12, 14 and 16, fluidly connected to one another. Any number of tanks may be used to carry out the invention. One tank is fluidly connected to a successive tank, starting from the first tank to the last tank.

Each tank may be provided with an inlet pipe 18 that directs a flow of air into the tank. One or more blowers 20 (or pumps, the terms being used interchangeably) may be provided to force air to flow into the tank or from one tank to another.

Each tank includes a different chemical agent toxic to a different contaminant in the air. For example, the first tank 12 may contain a sulfite compound, such as but not limited to, H₂SO₃. The second tank 14 may contain a chlorine compound, such as but not limited to, HClO. The chlorine compound may kill pathogenic bacteria, such as but not limited to, coli, salmonella and listeria. The sulfite compound may kill yeast and mold. Other substances that may be used to kill contaminants include, without limitation, caustic soda (NaOH) or sulfuric acid (H₂SO₄), which may kill spores. The third tank 16 may include a substance (e.g., hydrogen peroxide) that reacts with one or more of the chemical agents to alter (e.g., neutralize) them. For example, sulfur dioxide has a very high vapor pressure and it is quite possible that some of the sulfur dioxide may be carried into the moisture of the air stream. However, chlorine and hydrogen peroxide neutralize the sulfur dioxide residue. Thus, in this non-limiting example, air may be first bubbled through the sulfite solution in first tank 12, then scrubbed and passed through chlorine solution in second tank 14 and finally enter the third tank 16 in order to get rid of the sulfur dioxide and neutralize the effect of chlorine. The air may be scrubbed again to remove droplets of hydrogen peroxide.

The chemical agents may be in a solution, and air may bubble through the solution and exit at the top of the tank. A droplet separation device 22 may be provided to separate droplets of solution from the air stream exiting the tank. The droplet separation device 22 may include, without limitation, a cyclone, wherein droplets are removed as a result of a change in direction of the gas flow. In the cyclone, a highly swirling gas flow is generated through a static swirl element. The droplets are subjected to acceleration forces, moving them towards a surface onto which they coalesce, thus establishing separation.

It is noted that the first tank 12 may contain the chlorine compound and the second tank 14 may contain the sulfite compound. Of course, other compounds may be used as well.

One of the many applications of the present invention is in the packaging industry. In such an application, an enclosure 24 may be provided with points of ingress and egress 26 and 28, respectively, for packaging materials and food products, for example. Air may enter the first tank 12 from the enclosure 24. Air exiting the last tank 16 (which is now sterilized) may be re-introduced (e.g., by means of a pump 30) into the enclosure 24 and back to the first tank 12. Positive pressure air may be released from enclosure 24 to the atmosphere preventing contaminated atmospheric air from entering at the port of entry and exit of the packaging materials or foodstuffs, for example. (Other examples of enclosure 24 include hospital rooms, surgery suites, public places, etc.)

Since treated air escapes from the enclosure 24 at the points of ingress and egress 26 and 28, the air lost may be replenished by introducing air directly into tank 12, such as by means of a pump 34 and piping 36. The pump 34 may provide the extra pressure that pushes the air out of enclosure 24 at the points of ingress and egress 26 and 28.

In one non-limiting example, the air in the enclosure may be exchanged at a rate of 10-20 times per hour. The air may be recirculated at all times, including during the time the system is cleaned and during production breaks. The invention may ensure that there are no airborne bacteria or other microorganisms (e.g., spores) in the air of the enclosure 24.

The solutions in the tank may be controlled to keep the concentration of the solutions at some optimal value, such as but not limited to, about 3-5%.

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

1. Air purification system comprising:
a series of tanks fluidly connected to one another, one tank being fluidly connected to a successive tank, starting from a first tank to a last tank, each tank receiving therein air to be treated, wherein each tank comprises a different chemical agent toxic to a different contaminant in said air and wherein air treated by the chemical agent in one tank flows to a successive tank for treatment by the chemical agent in that successive tank.

2. The air purification system according to claim 1, further comprising at least one blower adapted to force air to flow into at least one of the tanks.

3. The air purification system according to claim 1, wherein for each tank, said chemical agents are in a solution, and air bubbles through the solution and exits at the top of the tank.

4. The air purification system according to claim 3, further comprising a droplet separation device adapted to separates droplets of solution from the air stream exiting the tank.

5. The air purification system according to claim 1, wherein said chemical agent comprises at least one of chlorine compound and a sulfite compound.

6. The air purification system according to claim 1, wherein one of said tanks comprises a substance that reacts with at least one of the chemical agents.

7. The air purification system according to claim 6, wherein said substance is adapted to neutralize at least one of the chemical agents.

8. The air purification system according to claim 6, wherein said substance comprises hydrogen peroxide.

9. The air purification system according to claim 1, wherein air exiting the last tank is re-introduced into the first tank.

10. The air purification system according to claim 1, wherein air that has been treated in said tanks is pumped out of an enclosure at points of ingress and egress of the enclosure.

11. The air purification system according to claim 10, further comprising a pump adapted to introduce air directly into the first tank through piping and to replenish air that leaves the enclosure.

12. A method for air purification comprising:
introducing air into at least one tank;
killing a microorganism in said air with a chemical agent in said at least one tank;
extracting purified air from at least one tank that contains no microorganism or chemical; and
introducing the purified air into an enclosure.
